(19) United States
(12) Patent Application Publication
(10) Pub. No.: US 2013/0332451 A1
(43) Pub. Date: Dec. 12, 2013

(54) SYSTEM AND METHOD FOR CORRELATING PERSONAL IDENTIFIERS WITH CORRESPONDING ONLINE PRESENCE

(71) Applicant: FLIPTOP, INC., San Francisco, CA (US)

(72) Inventors: Doug Camplejohn, San Francisco, CA (US); Dan Chiao, South San Francisco, CA (US); Jerry Chou, Taipei (TW); Tom Lee, Mountain View, CA (US); Kevin Liu, Seattle, WA (US); Robbie Cheng, Taipei (TW); Chiahung Lin, Taipei (TW); Johnson Hsiang, Taipei (TW); Winston Chen, Taipei (TW); Steven Kao, Taipei (TW); Haoji Wu, Taipei (TW); Aleksandra Bailey, San Francisco, CA (US); Polina Grinbaum, San Francisco, CA (US)

(73) Assignee: FLIPTOP, INC., San Francisco, CA (US)

(21) Appl. No.: 13/788,654

(22) Filed: Mar. 7, 2013

Related U.S. Application Data
(63) Continuation-in-part of application No. 13/490,436, filed on Jun. 6, 2012.

(51) Int. Cl. G06F 17/30

(52) U.S. Cl. CPC G06F 17/30867
USPC 707/722

(57) ABSTRACT

A system and method for correlating personal identifiers with corresponding online presence are disclosed. A particular embodiment includes providing, by use of a data processor, a user interface to enable a user to specify a person or personal identifier of interest; producing search terms associated with the person or personal identifier of interest; using the search terms in a search query to obtain related search results collected from a plurality of content sources; filtering the search results to obtain information indicative of a plurality of profile sources; using the information indicative of a plurality of profile sources to obtain related profiles collected from a plurality of profile sources; filtering the related profiles to obtain a set of matching profiles; and reporting information on the person or personal identifier of interest and links to the corresponding matching profiles to the user.

### PRIORITY PATENT APPLICATION

This is a continuation-in-part patent application of co-pending U.S. patent application Ser. No. 13/490,436; filed Jun. 6, 2012 by the same applicant. This present patent application draws priority from the referenced patent application. The entire disclosure of the referenced patent application is considered part of the disclosure of the present application and is hereby incorporated by reference herein in its entirety.

### TECHNICAL FIELD

This patent application relates to a system and method for use with networked computer systems, according to one embodiment, and more specifically, to a system and method for correlating personal identifiers with corresponding online presence.

### BACKGROUND

The content available to networked computer users has increased significantly in recent years. Content sources accessible on public data networks can include search engines, social networks, personal. websites or blogs, email hosts, businesses, or any of a variety of providers of network transportable digital content. Often, these content sources can include information related to people of interest or associated personal identifiers. Increasingly, organizations and people are using various network sites, on-line communities, or social network sites for interacting with each other, Social networks have gained in popularity as people have started to use content sources and content itself as a basis for connecting with each other. Various conventional sites, such as facebook.com, twitter.com, linkedin.com, and youtube.com are just a. few examples of the community of content sources and social networks that have grown in popularity.

As the numbers and size of the content sources and social networks expand, it becomes more difficult to track and correlate the identities of the content sources and related people or associated personal identifiers across the community of content sources and social networks.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for correlating personal identifiers with corresponding online presence;

FIG. 2 illustrates a detail of the personal data acquisition module in an example embodiment;

FIGS. 3 through 5 illustrate details of the personal data acquisition module and the personal data processing module of an example embodiment;

FIG. 6 illustrates the user services module of an example embodiment;

FIG. 7 illustrates a sample subscriber report produced by an example embodiment;

FIG. 8 illustrates another example embodiment of a networked system in which various embodiments may operate;

FIG. 9 is a processing flow chart illustrating an example embodiment of a personal correlation management system as described herein;

FIG. 10 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

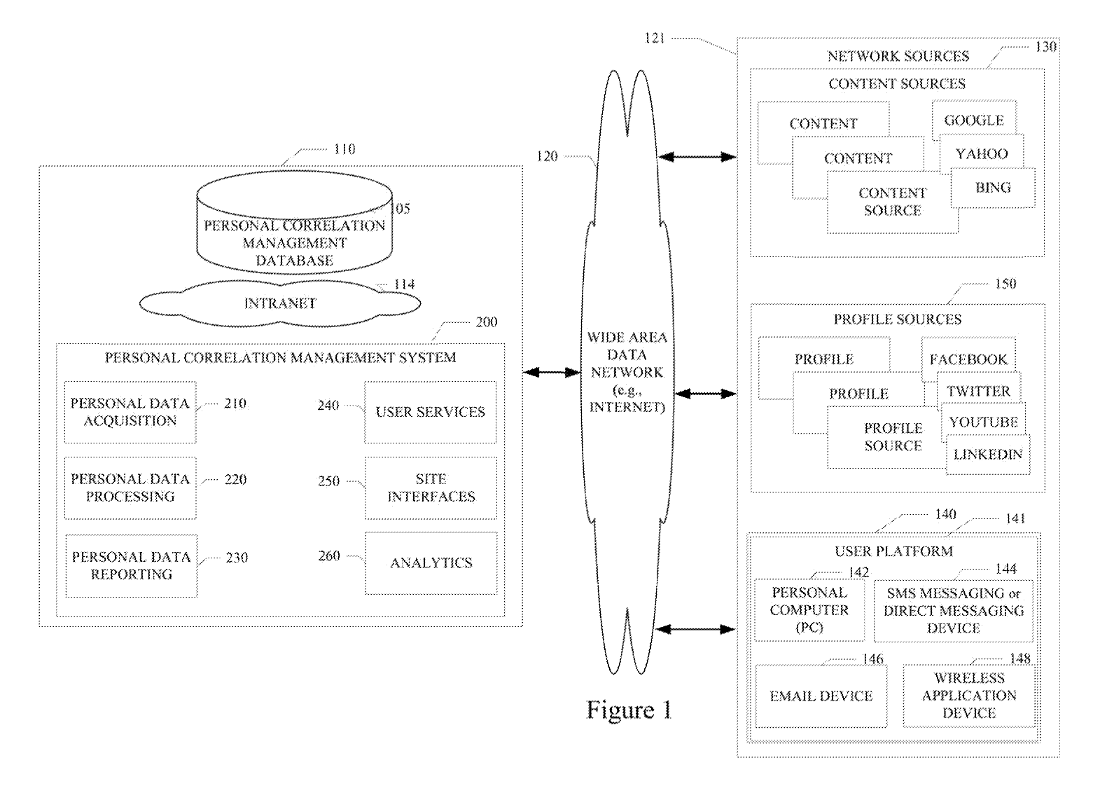

Referring to FIG. 1, in an example embodiment, a system and method for correlating personal identifiers with corresponding online presence are disclosed. In various example embodiments, an application or service, typically operating on a host site (e.g., a website) 110, is provided to simplify and facilitate personal correlation for a user at a user platform 140 from the host site 110. The host site 110 can thereby be considered a personal correlation management site 110 as described herein. Multiple network sources 121 are used by the personal correlation management site 110 to obtain data. For example, content sources 130 provide a plurality of content sources, which can be searched using conventional search engines, such as Google, Yahoo, Bing, and the like. Content sources 130 can also be accessed directly using a link or uniform resource locator (URL). Content sources 130 represent the variety of web pages, documents, images, video, audio, media, and other forms of content available via a wide area data network, such as the Internet 120. For example, content sources 130 can include web pages on which a particular person of interest may be listed or linked. Profile sources 150 are network-accessible sites on which individuals, businesses, organizations, or other entities may create profiles that provide information about the entity and a means for communicating with the entity. Such profiles can include organizational information, product/service information, contact information, historical information, or a wide variety of structured or unstructured information related to a particular entity. Various conventional sites, such as facebook.com, twitter.com, youtube.com, and linkedin.com are just a few examples of the available profile sources 150. It will be apparent to those of ordinary skill in the art that content sources 130 can be any of a variety of networked content providers. It will also be apparent to those of ordinary skill in the art that profile sources 150 can include a variety of network sites including, social network sites, data aggregation sites, marketing sites, financial sites, and the like. The personal correlation management site 110, content sources 130, profile sources 150, and user platforms 140 may communicate and transfer information via a wide area data network (e.g., the Internet) 120. Various components of the personal correlation management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs). direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly,

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (OSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which inform-nation may travel between one computing device and another computing device, network, and the like. In one embodiment, network 114 may represent a LAN that is configured behind a firewall (not shown), within a business data center, for example.

The content sources 130 may include any of a variety of providers of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein.

In a particular embodiment, a user platform 140 with one or more client devices 141 enables a user to access personal correlation management site 110 via the network 120. Client devices 141 may include virtually any computing device that is configured to send and receive information over a network, such as network 120. Such client devices 141 may include portable devices 144 or 146 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141. may also include other computing devices, such as personal computers (PCs) 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

Client devices 141 may also include at least one client application that is configured to receive content or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. Client devices 141 may also include a wireless application device 148 on which a client application is configured to enable a user of the device to send and receive information to/from network sources 121 wirelessly via the network 120.

Referring still to FIG. 1, host site 110 of an example embodiment is shown to include a personal correlation management system 200, Intranet 114, and personal correlation management database 105. Personal correlation management system 200 includes personal data acquisition module 210. personal data processing module 220, personal data reporting module 230, user services module 240, site inter ace module 250, and analytics module 260. Each of these modules can be implemented as software components executing within an executable environment of personal correlation management system 200 operating on host site 110. Each of these modules of an example embodiment is described in more detail below in connection with the figures provided herein.

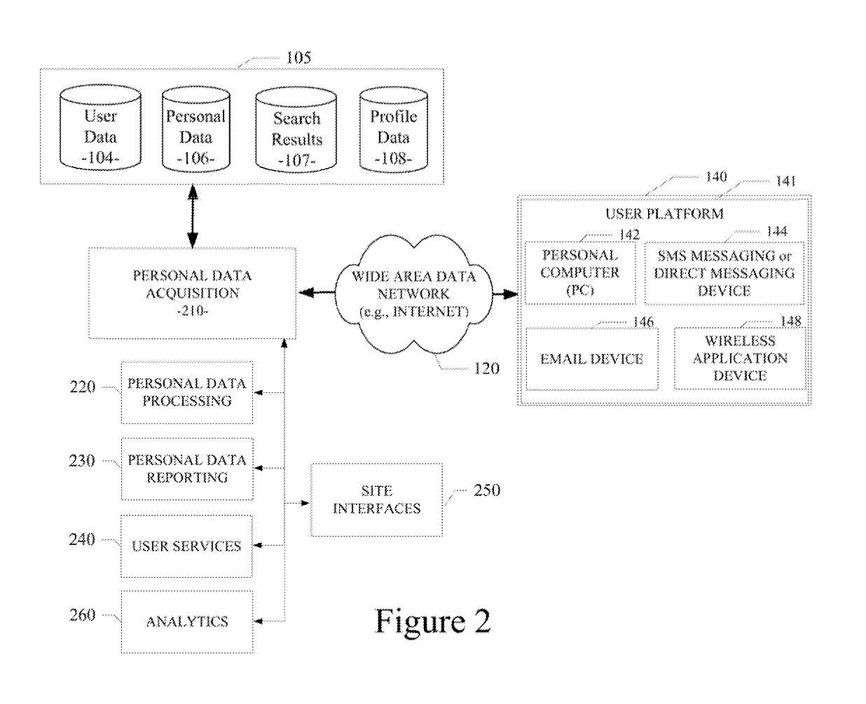

Referring now to FIG. 2, a detail of the personal data acquisition module 210 in an example embodiment is illustrated. As shown, personal data acquisition module 210 is in data communication with a user platform device 140, one or more portions of data storage device 105, and the other processing modules 220 through 260 of the personal correlation management system 200. In general, the personal data acquisition module 210 is responsible for enabling a user to specify and/or configure one or a plurality of people of interest in a set of personal information, which can be stored in personal data store 106, and from which and/or for which search terms are extracted or created. The one or plurality of people of interest can be specified by enabling the user to specify, for example, a name, location, job title, an email address, a social profile Uniform Resource Locator (URL) or account handle, contact information, employer affiliation, photo, voice sample, biometric, and/or the like that identifies a particular individual person with as much specificity as possible. The personal data acquisition module 210 can then use the search terms in a search query to obtain related search results collected from a variety of content sources 130 and stored in search result data store 107. Finally, the personal data acquisition module 210 uses filtered search results to obtain related personal profiles collected from a variety of profile sources 150 and stored in profile data store 108. The personal data acquisition module 210 can also be considered a web front end module that can interact with users at user platforms 140 via a graphical user interface and with other network sources 121 via application programming interfaces (API's) as described in more detail below.

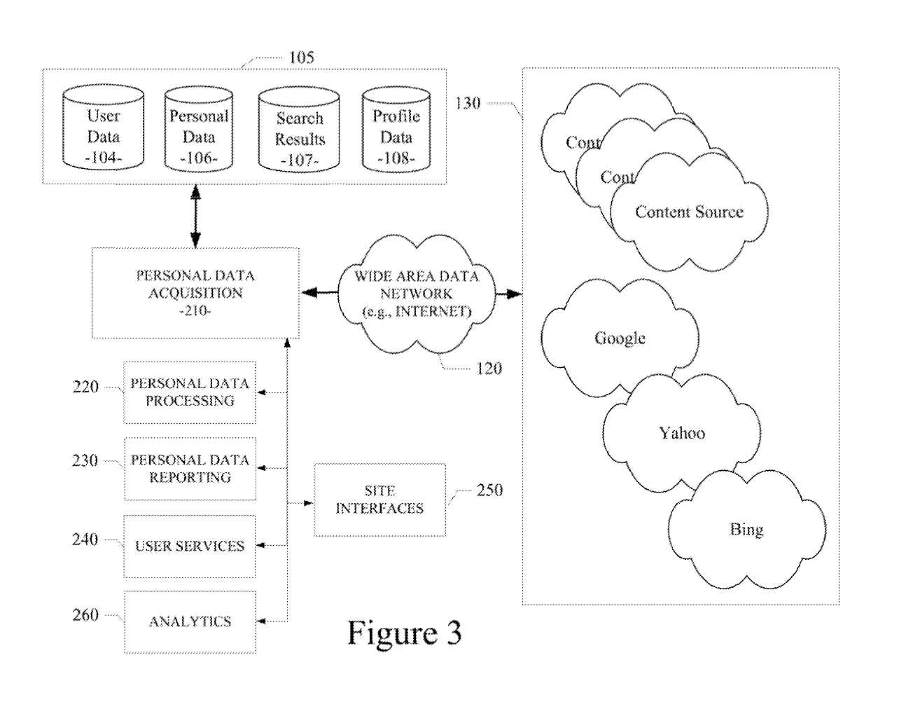

Referring now to FIGS. 3 through 5, a detail of the personal data acquisition module 210 and personal data processing module 220 in an example embodiment is illustrated. As shown, personal data acquisition module 210 is in data communication with a plurality of content sources 130, one or more portions of data storage device 105, and the other processing modules 220 through 260 of the personal correlation management system 200. As described above, the personal data acquisition module 210 uses the search terms derived from user-specified personal information in a search query to obtain related search results collected from a variety of content sources 130 and stored in search result data store 107. In an example embodiment, the personal data. acquisition module 210 can use application programming interfaces (APIs) provided through site interfaces module 250 to obtain search results from a variety of conventional search engines, such as Google, Yahoo, and Bing, among others. As well known to those of ordinary skill in the art, the search terms derived from user-specified personal information can be modified or augmented to maximize the likelihood of obtaining relevant and useful search results. For example, plural forms or root forms of keywords can be added or removed from the search terms submitted to a particular search engine. Additionally, conjunctions or special characters compatible with the syntax for a particular search engine can be added or removed to the search terms submitted to a particular search engine. In other cases, the search terms derived, from user-specified personal information can be modified or augmented to add or remove similar or related keywords from a matching category or grouping of related keywords. In this manner, the search terms derived from user-specified personal information can be submitted in a search query to a particular search engine thereby producing search results.

In a similar manner, the personal data acquisition module 210 can be configured to use the user-provided personal information, and/or the extracted or created search terms, to directly access particular content sources 130. For example, the user may have provided a uniform resource locator (URL) along with a particular person's name as part of the personal in formation. The URL. can be identified by the particular structure of a textual. string. The user-provided personal URL, if any, can be used to access one or more webpages at a personal website accessible through use of the personal URL. These webpages at the personal website can be added to the search results obtained via the search engines as described above. Additionally, the person's name itself, and derivatives thereof, can be used by the personal data acquisition module 210 to correlate various other URLs that may correspond to a person or personal identifier and may produce relevant content. The various other URs may be provided by a third party or derived through the search process. For example, given a user-specified personal name, such as ‘John Smith’, the personal data acquisition module 210 can automatically correlate various other URLs, such as www.johnsmith.com, www.johnsmith.net, www.jsmith.com, www.smithjohn.com, etc. These automatically correlated personal URLs can be accessed by the personal data acquisition module 210 to obtain any content at these sites, if any. This content can also be added to the search results obtained via the search engines as described above.

In a particular example embodiment, the personal data acquisition module 210 can also be configured to process non-textual sources of information that can be associated with the particular person or personal identifier provided by the user. For example, a user can provide a photo, voice sample, or biometric of a person of interest. The term, ‘biometric’ refers to unique physiological and/or behavioral characteristics of a person that can be measured or identified. Example characteristics include height, weight, fingerprints, retina or iris patterns, skin and hair color, physiological feature characteristics: facial feature characteristics, photographic image, voice patterns, and any other measurable metrics associated with an individual person. Conventional identification systems that use biometrics to recognize irises, voices, or fingerprints have been. developed and are in use. These systems provide highly reliable identification, but require special equipment to read the intended biometric (e.g., fingerprint pad, eye scanner, etc.). Conventional identification systems can also compare photographic images or voice samples of an individual and extract features used for matching biometrics of an individual between two photos or two voice samples. These conventional biometric identification systems can be used in an example embodiment to provide additional information for verifying the identity of a particular person of interest as compared with information found in the various searches performed as described herein. For example, as described above, a user can specify, for example, photo, voice sample, biometric, and/or the like that identifies a particular individual person of interest. The personal data acquisition module 210 can then use search terms in a search query to obtain related search results collected from a variety of content sources 130 and stored in search result data store 107. The search results may include photos, voice samples, biometrics, and/or the like that identify particular individual people. For example, the search results may include a social profile of a potentially matching person, wherein the social profile includes a photo of the person corresponding to the social profile. In the example embodiment, the photo from the search results can be compared with the photo of the person of interest provided by the user. Using conventional techniques, features can be extracted from each of the photos and compared for similarity. If the photo features match within a pre-defined and configurable level of similarity, the photo of the person of interest can be considered to correspond to the photo of the person associated with the social profile in the search results. In this case, the additional information from the social profile in the search results can be extracted and used to seed further search queries for additional search results related to the person of interest.

In a similar manner, the original search results may include a social profile of a potentially matching person, wherein the social profile includes a voice sample or other biometric of the person corresponding to the social profile. In the example embodiment, the voice sample or other biometric from the search results can be compared with the voice sample or other bionmetric of the person of interest provided by the user. Using conventional techniques, features can be extracted from each of the voice samples or other biometrics and compared for similarity. If the voice sample features or other biometric features match within a pre-defined and configurable level of similarity, the voice sample or other biometric of the person of interest can be considered to correspond to the voice sample or other biometric of the person associated with the social profile in the search results. In this case, the additional information from the social profile in the search results can be extracted and used to seed further search queries for additional search results related to the person of interest.

The personal data acquisition module 210 can also be configured to create various file names, folder names, document names, publication titles, and the like, that may produce content relevant to a particular user-specified person or personal identifier. These file/folder/document/publication names can be added to the search terms submitted to the search engines. Any search results generated by these names can be added to the search results obtained via the search engines as described above.

Using the variety of techniques described above for generating a set of search results related to the user-specified personal information, the search results themselves can be automatically scanned and used to extract additional keywords, URLs, and/or file/folder/document/publication names, which can be used in additional search queries or direct website accesses to obtain additional content that may be relevant to the user-specified personal information. The process of scanning search results and extracting additional keywords can be repeated as necessary to produce a sufficiently robust set of search results.

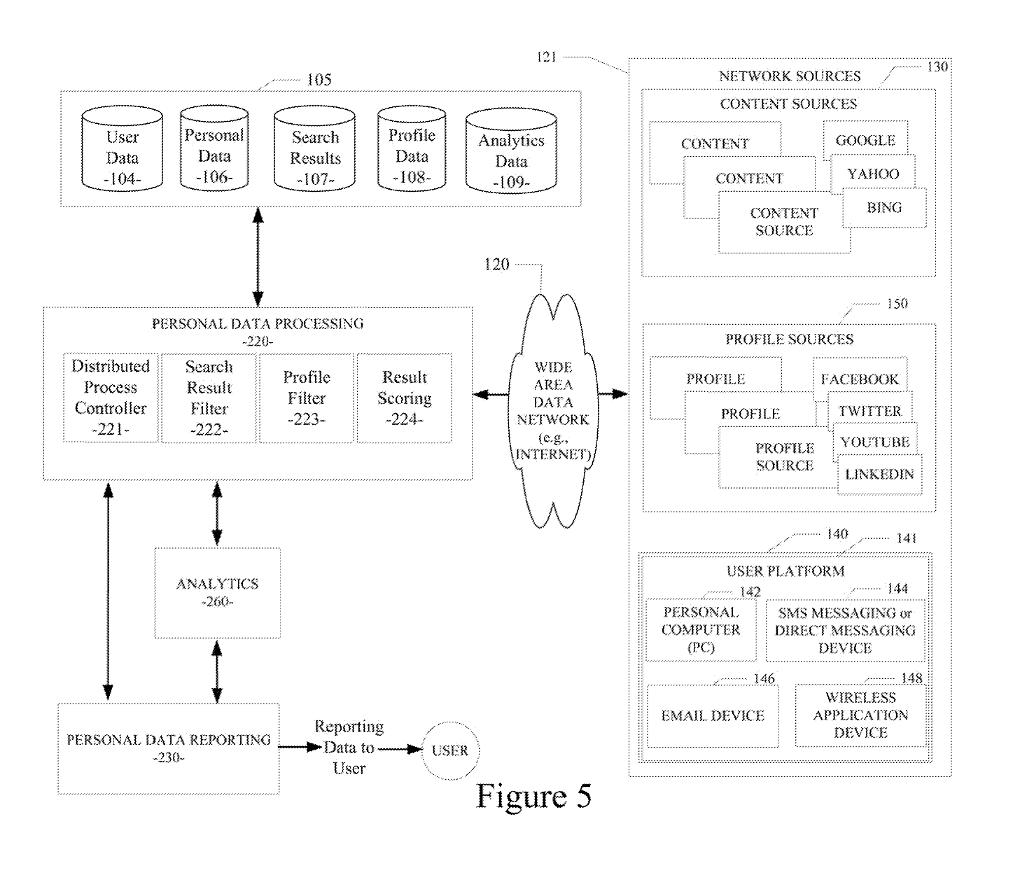

As shown in FIG. 5, the personal data processing module 220 includes a distributed process controller 221 in a particular embodiment. The distributed process controller 221 can be used to deploy a plurality of distributed processes, which can perform the search queries or direct website accesses to obtain additional content that may be relevant to the user-specified personal information. The distributed processes can be serial or parallel processes implemented on one or more physical and/or virtual machines using conventional techniques. The distributed process controller 221 can also use a batch controller to collect the search results in off-line processes. The distributed process controller 221 can also be considered a back end module that can interact with content sources in an off-line mode via application programming interfaces (AP's) as described in more detail herein. The use of a plurality of distributed processes serves to improve the efficiency and speed of the processing operations to obtain the search results representing the content that may be relevant to the user-specified personal information.

Once a set of search results, which are potentially relevant to the user-specified personal information, is produced as described above, the search results are processed by the search result filter 222 of the personal data processing module 220 as shown in FIG. 5. The search result filter 222 operates to identify content in the search results that is relevant to the person or personal identifier specified in the user-specified personal information. Any content in the search results that is determined to be not relevant to the person or personal identifier specified in the user-specified personal information is removed. The search result filter 222 uses a variety of search result filtering operations to process the search results. For example, the search result filter 222 can scan a home page obtained by a direct website access using the personal URLs accessed by the personal data acquisition module 210. If the home page contains a URL or link to a page or site associated with the person or personal identifier of interest, the home page (and thus the means for accessing the home page) is considered relevant to the person or personal identifier specified in the user-specified personal information. The search result filter 222 can also scan a page of the search results to determine if the page title of the scanned page includes a reference to the person or personal identifier of interest. The search result filter 222 can also determine if a page of search result content includes a reference to the person or personal identifier of interest, a URL associated with the person or personal identifier, or content known to be related to the person or personal identifier of interest. In each of these cases, the search result content (and thus the means for accessing the content) is considered relevant to the person or personal identifier specified in the user-specified personal information, in other filtering processes, the search result filter 222 can scan the search result content for pages known to be not relevant to the person or personal identifier of interest. For example, the search result filter 222 can search for a URL in the search results that corresponds to a link known to be not relevant to the person or personal identifier of interest. In other filtering processes, the search result filter 222 can scan the search result content for pages that include a URL, which is in a particular format known to be associated with the person or personal identifier of interest or a URL, which is associated with one of the other social pages identified for that person or personal identifier. in other filtering processes, the search result filter 222 can scan the search result content for pages, which are formatted in a particular format and/or sequence known to be associated with the person. or personal identifier of interest. For example, the search result filter 222 can scan the search results for a sequence of pages that includes a hone page and a contact page. This particular sequence of pages may indicate relevance of the sequence of pages to the person or personal identifier of interest. Using a variety of filtering processes, the search result filter 222 identifies content in the search results that is relevant to the person or personal identifier specified in the user-specified personal information.

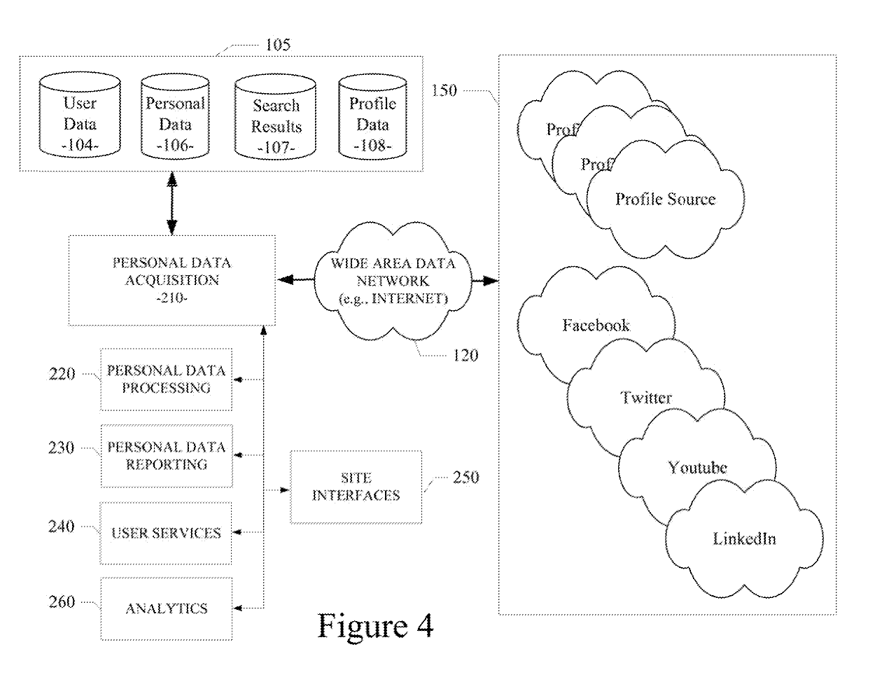

The filtered search results produced by the search result filter 222 can be used by the profile filter module 223 of the personal data processing module 220 as shown in FIGS. 4 and 5. The profile tilter module 223 can scan the filtered search results for links, URLs, references, pointers, names, or other identifiers associated with sites or network locations at which profiles are typically stored. These sites or network locations are referred to herein as profile sources 150 as shown in FIGS. 1, 4, and 5. The profile sources 15 can include any of a variety of social network sites, aggregator sites, marketplace sites, organizational sites, venue sites, and the like. The profile sources 150 represent any location, website, site, node, or other network accessible entity from which a profile or other entity-related dataset can be obtained. For example, social network sites such as facebook.com and twitter.com, for example, provide profiles that can be accessed, viewed, and retrieved by the personal data acquisition module 210. Other profile sources 150, such as youtube.com, linkedin.com, and/or any of a variety of other conventional sites may similarly be accessed for profile information. The profile filter module 223 can extract any links or identifiers of these profiles sources 150 that may appear in the search results. The profile filter module 223 can use the personal data acquisition module 210 to obtain the corresponding profiles from the identified profile sources 150.

When a profile is obtained in the manner described above, the profile filter module 223 can scan the obtained profile to identify any content in the profile that is relevant to the person or personal identifier specified in the user-specified personal information. The profile filter module 223 can use a variety of profile filtering operations to process the profile. For example, the profile filter module 223 can scan the profile for the presence of a link or URL, directed to a page corresponding to a page known. to be associated with the person or personal identifier of interest. If the profile contains a link back to a site known to be associated with the person or personal identifier of interest, it is highly likely that the profile is associated with the person or personal identifier of interest. Similarly, if the profile contains a link to another page and the linked page contains a link back to a site known to be associated with the person or personal identifier of interest, it is highly likely that the profile is associated with the person or personal identifier of interest. The profile filter module 223 can also scan the profile to determine if the profile includes a reference to a geographical location, contact information, keywords, URLs, or other information associated with the person or personal identifier of interest. If the profile filter module 223 determines that a particular profile is likely to be associated with the person or personal identifier of interest, the profile is identified as a matching profile. A record of the matching profiles and links to the matching profiles is retained in the profile data store 108.

As part of the processing performed by the profile filter module 223, the profile filter module 223 can also scan each profile for links, URLs, or identifiers of other profile sources 150. For example, a facebook.com profile for a particular person or personal identifier of interest may include a button or link to a corresponding presence on twitter.com. The profile filter module 223 can extract these links to other profile sources 150 and use the personal data acquisition module 210 to obtain the profiles from these other profile sources 150. The profiles obtained from these other profile sources 150 can be similarly processed by the profile filter module 223 as described above. Any profiles found to be associated with the person or personal identifier of interest are added to the set of matching profiles.

Once the search result filter module 222 and profile filter module 223 have processed the search results and profiles as described above, a set of profiles likely matching the person or personal identifier of interest is generated. Given that the set of matching profiles was derived from a variety of content. sources 130 and profile sources 150, the likelihood that a particular profile of the set of matching profiles is actually related to the person or personal identifier of interest can vary significantly. This likelihood of relatedness or relevance score is quantified using the result scoring module 224 of personal data processing module 220. A variety of factors can be used to generate a relevance score, which quantifies the likelihood or confidence level that a particular profile is actually related to the person or personal identifier of interest. For example, the result scoring module 224 can determine if a profile contains a link back to a site known to be associated with the person or personal identifier of interest. If this is the case, the corresponding profile can receive a high relevance score, where a high relevance score corresponds to a high likelihood that the profile is associated with the person or personal identifier of interest. The result scoring module 224 can also use metrics available on particular sites to determine if a profile is highly relevant to the person or personal identifier of interest. For example, a particular profile associated with a high quantity of facebook.com ‘likes’, twitter.com ‘followers’, and/or youtube.com ‘views’ is likely to be highly relevant to the person or personal identifier of interest and thus scored highly. The collected metrics can also include the quantity of clicks. click-throughs, ‘likes’, ‘shares’, ‘retweets’, comments, mentions, and the like that are related to input provided by particular subscribers on the corresponding profile source. The metrics from each profile source can be collected by the personal data acquisition module 210 using various API's provided by the profile source through site interfaces 250. In addition, related metadata can also be collected. The metadata can also be used to relate profiles with corresponding people or personal identifiers of interest.

The result scoring module 224 can also determine if a particular profile includes a reference to a geographical location, contact information, keywords, URLs or other information closely associated with the person or personal identifier of interest, if such determinations are made, the corresponding relevance score can be adjusted to a higher value. In the manner described above, the result scoring module 224 can generate and apply a relevance score to each of the profiles in the set of matching profiles. The relevance scores can be retained in the profile data 108.

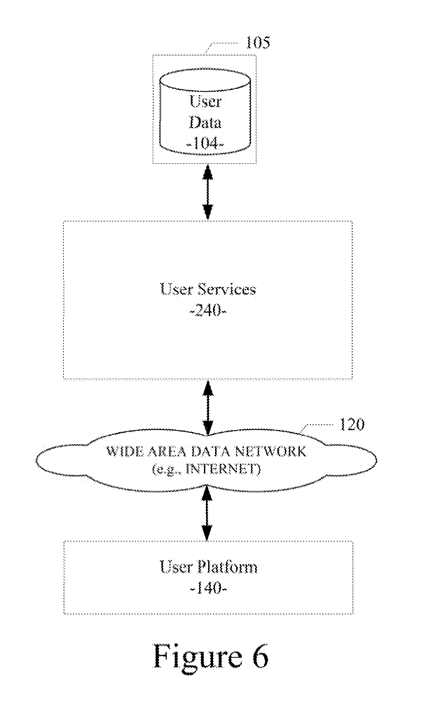

Referring to FIG. 6, a user interface is provided by the user services module 240 and presented to the user via the user platform 140. User services module 240 provides the functionality with which a networked computer user operating from a user platform 140 can become a user/member of a personal correlation management service of host site 110 and interact with the personal correlation management services provided by the personal correlation management system 200. These user personal correlation management services can be implemented by several functional components provided by the personal correlation management system 200 as described herein. In an example embodiment, the functional components provided by the user services module 240 can include a user account module and a payment module. The user account module can be used to create and maintain a user account on the host site 110. The user account module can also be used to configure user settings, create and maintain a user/user profile on host site 110, and otherwise manage user data and operational parameters on host site 110. The user data and operational parameters can be retained in database 104. The payment module can be used to submit payment for a user account and for enabling various user services. As described above, the user interface can also be used to enable a user to specify and/or configure one or a plurality of people or personal identifiers of interest in a set of personal information, The personal information can be retained in personal data 106. Additionally, when setting up and/or configuring a user account on host site 110, the user can also provide the authentication credentials necessary to access the user account,

In an example embodiment, the analytics module 260 can generate data sets that correspond to an online presence relative to a plurality of people or personal identifiers. Similarly, the analytics module 230 can also generate data sets that correspond to the aggregated data relative to a plurality of content sources and/or profile sources. Moreover, the analytics module 230 can also generate aggregate relevance scores that correspond to the aggregated online presence relative to a plurality of people or personal identifiers, a plurality of content sources, and a plurality of profile sources. Thus, the analytics module 230 can generate a variety of relevance score data that corresponds to an online presence across multiple people or personal identifiers, multiple content sources, and multiple profile sources. These generated analytics data can be computed by the analytics module 260 and stored in analytics database 109 shown in FIG. 5.

Referring still to FIGS. 2 through 5, the personal data reporting module 230 is responsible for generating reports, graphs, and other output data to convey information to a user of host site 110. As described above, the personal data acquisition module 210 and the personal data processing module 220 collect and generate data related to people or personal identifiers of interest. Additionally, the analytics module 260 generates data. sets related to people or personal identifiers, content sites, and profile sources. This information, retained in database 105, can be accessed. and formatted. into various reports, pages, lists, graphics, and the like as requested by a user.

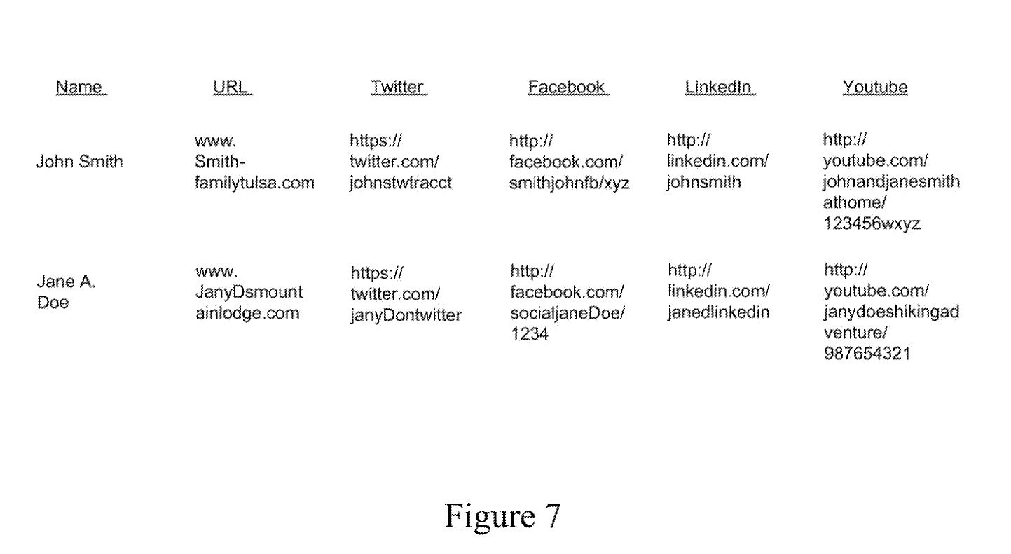

FIG. 7 illustrates a sample subscriber report produced by an example embodiment. The sample subscriber report shows the personal identifiers associated with each of the people of interest who have been associated with online presence information corresponding to several profile sources as determined by an example embodiment. For each person or personal identifier of interest, the report shows the associated online presence information. For example, the sample report of FIG. 7 shows the profile source links (e.g., Twitter, Facebook, LinkedIn, and Youtube) along with the personal URL for each of several people or personal identifiers. As described above, the data presented in this sample report was collected and generated by the personal data acquisition module 210, the personal data processing module 220, the personal data reporting module 230, and the analytics module 260 based on the user-specified personal information, the related search. results, and related profile data. as described above.

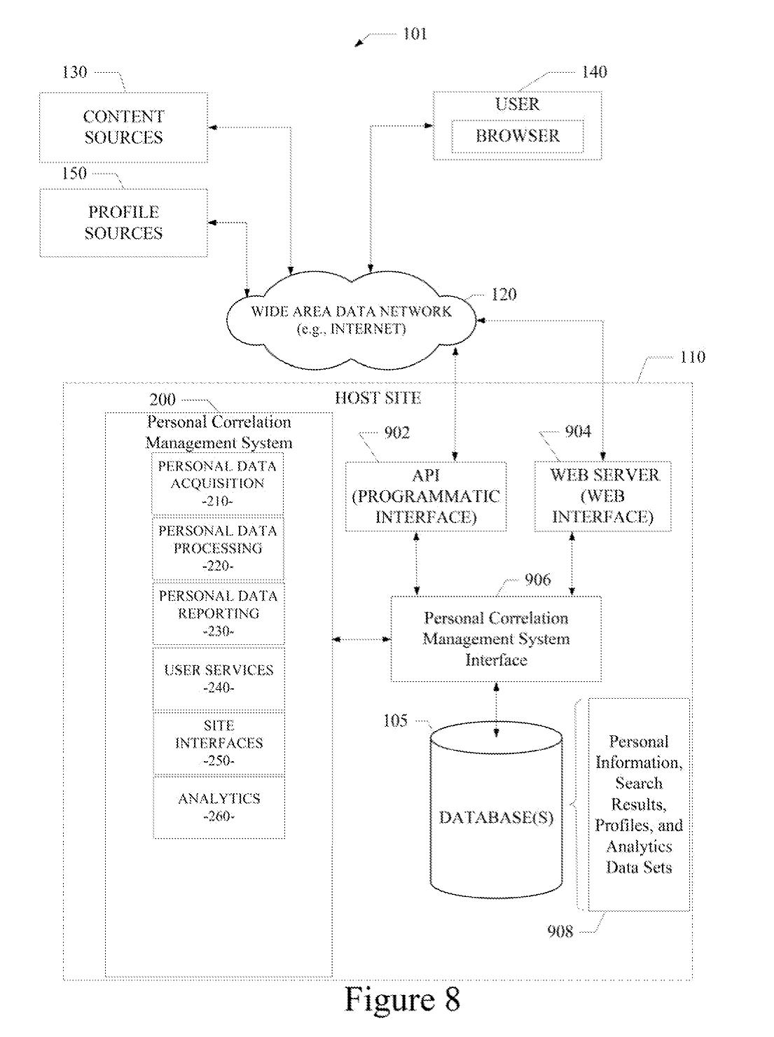

Referring now to FIG. 8, another example embodiment 101 of a networked system in which various embodiments may operate is illustrated. In the embodiment illustrated, the host site 110 is shown to include the personal correlation management system 200. The personal correlation management system 200 is shown to include the functional components 210 through 260 as described above. In a particular embodiment, the host site 110 may also include a web server 904 having a web interface with which. users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the personal correlation management system 200 either directly or via an interface 906. The personal correlation management system 200 may also be configured to access a data storage device 105 either directly or via the interface 906.

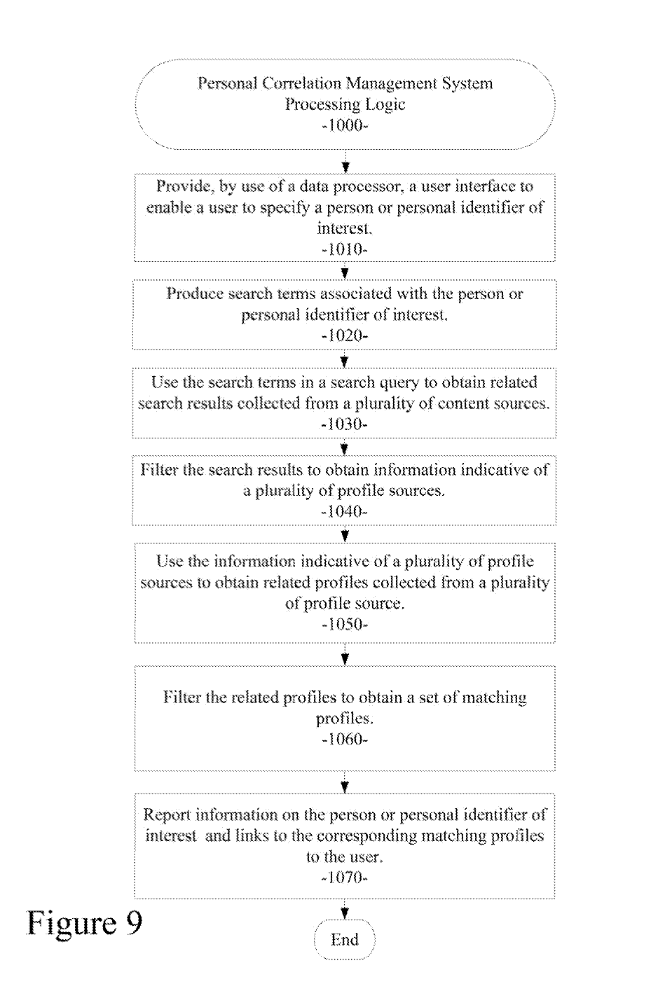

FIG. 9 is a processing flow diagram illustrating an example embodiment of a personal correlation management system as described herein. The method of an example embodiment includes: providing, by use of a data processor, a user interface to enable a user to specify a person or personal identifier of interest (processing block 1010); producing search terms associated with the person or personal identifier of interest (processing block 1020); using the search terms in a search query to obtain related search results collected from a plurality of content sources (processing block 1030); filtering the search results to obtain information indicative of a plurality of profile sources (processing block 1040); using the information indicative of a plurality of profile sources to obtain related profiles collected from a plurality of profile sources (processing block 1050); filtering the related profiles to obtain a set of matching profiles (processing block 1060); and reporting information on the person or personal identifier of interest and links to the corresponding matching profiles to the user (processing block 1070).

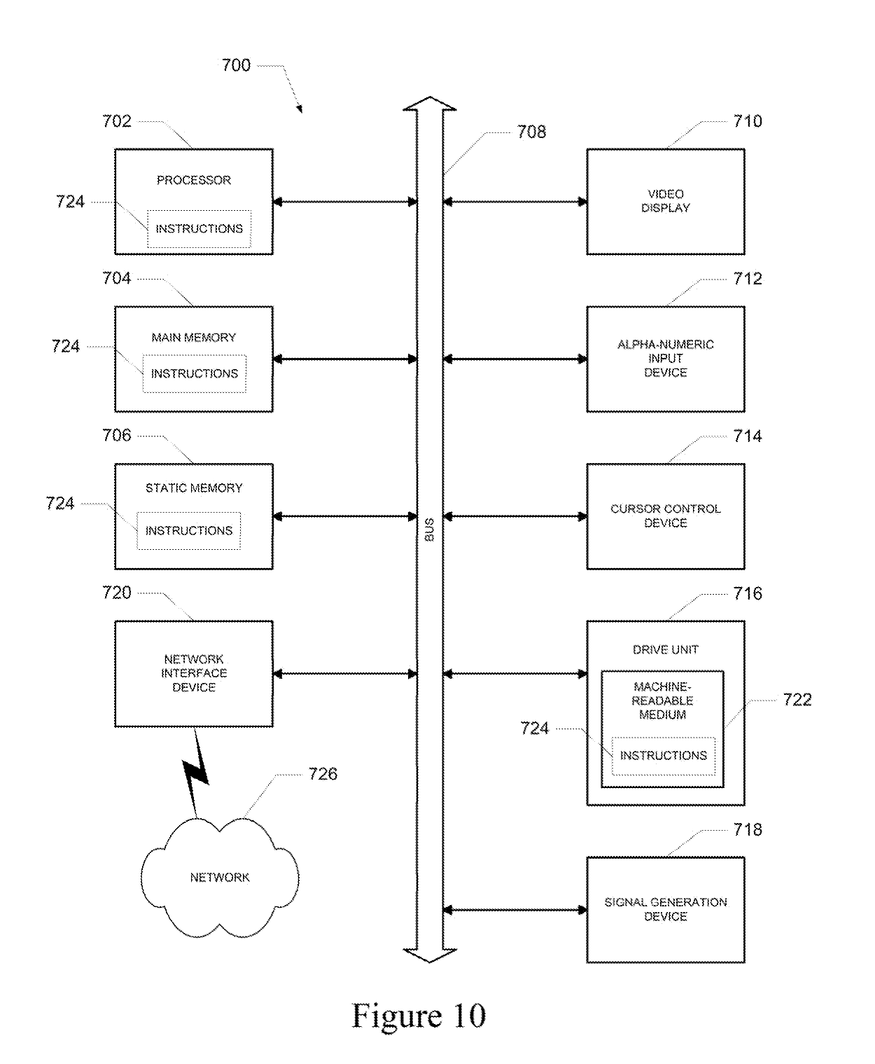

FIG. 10 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed. herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g. a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment,

We claim:

1. A method including:
providing, by use of a data processor, a user interface to enable a user to specify a person or personal identifier of interest;
producing search terms associated with the person or personal identifier of interest;
using the search terms in a search query to obtain related search results collected from a plurality of content sources;
filtering the search results to obtain information indicative of a plurality of profile sources;
using the information indicative of a plurality of profile sources to obtain related profiles collected from a plurality of profile sources;
filtering the related profiles to obtain a set of matching profiles; and
reporting information on other person or personal identifier of interest and links to the corresponding matching profiles to the user.

2. The method as claimed in claim 1 wherein each of the plurality of content sources represent a source of content accessible via a data network.

3. The method as claimed in claim 1 wherein each of the plurality of profile sources represent a source of a profile accessible via a data network.

4. The method as claimed in claim 1 wherein using the search terms in a search query to obtain related search results includes using a search engine.

5. The method as claimed in claim 1 wherein using the search terms in a search query to obtain related search results includes making a direct access to a website using a link.

6. The method as claimed in claim 1 wherein filtering the search results includes scanning a page of search result content for a reference to the person or personal identifier of interest.

7. The method as claimed in claim 1 wherein filtering the search results includes scanning search result content for pages that include a uniform resource locator (URL), which is in a particular format known to be associated with the person or personal identifier of interest.

8. The method as claimed in claim 1 wherein the user interface to enable a user to specify a person or personal identifier of interest being further configured to enable a user to specify a biometric of a person or personal identifier of interest, the biometric being used to filter the related profiles to obtain a set of matching profiles.

9. The method as claimed in claim 1 including determining if a profile contains a link. back to a site known to be associated with the person or personal identifier of interest.

10. The method as claimed in claim 1 including generating a relevance score corresponding to each of the profiles in the set of matching profiles.

11. A system comprising:
a data processor;
a database, in data communication with the processor, for storage of personal information; and
a personal correlation management module, executable by the processor, to:
provide, by use of the data processor, a user interface to enable a user to specify a person or personal identifier of interest;
produce search terms associated with the person or personal identifier of interest;
use the search terms in. a search query to obtain related search results collected from a plurality of content sources;
filter the search results to obtain information indicative of a plurality of profile sources;
use the information indicative of a plurality of profile sources to obtain related profiles collected from a plurality of profile sources;
filter the related profiles to obtain a set of matching profiles; and
reporting information on the person or personal identifier of interest and links to the corresponding matching profiles to the user.

12. The system as claimed in claim 11 wherein each of the plurality of content sources represent a source of content accessible via a data network.

13. The system as claimed in claim 11 wherein each of the plurality of profile sources represent a source of a profile accessible via a data network.

14. The system as claimed in claim 11 wherein using the search terms in a search query to obtain related search results includes using a search engine.

15. The system as claimed in claim 11 wherein using the search terms in a search query to obtain related search results includes making a direct access to a website using a link.

16. The system as claimed in claim 11 wherein filtering the search results includes scanning a page of search result content for a reference to the person or personal, identifier of interest.

17. The system as claimed in claim 11 wherein filtering the search results includes scanning search result content for pages that include a uniform resource locator (URL), which is in a particular format known to be associated with the person or personal identifier of interest.

18. The system as claimed in claim 11 wherein the user interface to enable a user to specify a person or personal identifier of interest being further configured to enable a user to specify a biometric of a person or personal identifier of interest, the biometric being used to filter the related profiles to obtain a set of matching profiles.

19. The system as claimed in claim 11 being further configured to determine if a profile contains a link back to a site known to be associated with the person or personal identifier of interest.

20. A non-transitory machine-useable storage medium embodying instructions which, when executed by a machine, cause the machine to:
provide, by use of a data processor, a user interface to enable a user to specify a person or personal identifier of interest;
produce search terms associated with the person or personal identifier of interest:
use the search terms in a search query to obtain related search results collected from a plurality of content sources;
filter the search results to obtain information indicative of a plurality of profile sources;
use the information indicative of a plurality of profile sources to obtain related profiles collected from a plurality of profile sources;
filter the related profiles to obtain a set of matching profiles; and
reporting information on the person or personal identifier of interest and links to the corresponding matching profiles to the user.
